(19) United States
(12) Patent Application Publication
(10) Pub. No.: US 2010/0039281 A1
(43) Pub. Date: Feb. 18, 2010

(54) Advertising Display and System

(76) Inventor: Clarence Harold Bandura, Fullerton, CA (US)

Correspondence Address: Rodney Corn, 814 N Hampton St, Anaheim, CA, 92801, US

(21) Appl. No.: 12/191,607

(22) Filed: Aug. 14, 2008

(51) Int. Cl. G08B 5/00

(52) U.S. Cl. 340/815.4

(57) ABSTRACT

A provision is made for electro-magnetic wave detection, and identification of a natural element for interactive display by, with same or but not limited to wearable, portable, personal assist items or devices. Unnatural element identifification also recognizes resonace or induction but as a by product of electric/electronic discharge/eminence for display therewith.

Network connections enable deployment: advertiser association, multicast, select scan, vehicle/carrier bodycounts, variable tracking for timed intervals, tracking carrier/advertiser local awareness or interactive pointing navigation device to dynamically reveal participants of prior network quiries with same. Diversity of the present invention is exemplified with the micro display platform; reactive absorbant material applied anatomically. Other features include multicast, mosaic, collective display, spectrum conversion, on/off page transition, character variable tracking, localzed or scanned from a network for multi-cast signals or participant/marker pointing navigation device activity.

### TECHNICAL FIELD

The field of the present invention involves electro-magnetic wave detection and identification of a natural element for illumated interactive display.

### BACKGROUND

By working hand in hand with technology of personal assist, wearable communication devices or items, advertising applications will follow suit but more recently, of a lesser degree as compared to cell phone, code division multiple access (CDMA) wideband (WCDMA), 3 or 4th generation, global system muliple telephone (GSM), WIMAX, and other wi-fi advancements where convergence of real world/digital display needs to meld ergonomically for improved consumer mobility. Tech advancecements have enabled advertising techniques or platforms a means for reactive interaction comprising: electo-magnetic wave detection, identification of natural elements, unnatural element by products, illuminative, reflective, vapor, reciprocal display and/or extensions thereof. Additionally wearable, portable, personal assist items or devices expand carrier applications and independent manned/unmanned displays.

### SUMMARY

The objective described with the present invention herein is to increase from display platforms user/advertiser participation and local or multiple deployment/allotment for electro-magnetic wave detection amongst featured illuminated display.

### BRIEF DESCRIPTION OF THE DRAWINGS

FIG. 1 illustrates a display environment of the present invention and embodiments therein where features of some embodiments may be substituted with others.

FIG. 2 illustrates a platform display environment and embodiment of the present invention.

### DETAILED DESCRIPTION

Other embodiments are evident with drawings, further specification review to those skilled in the art to which it pertains and may include structure, process, adjustable and other changes.

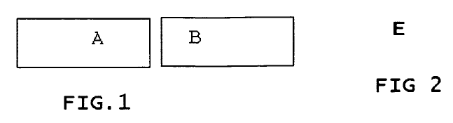

FIG. 1 illustrates an electro-magnetic wave detection within the present display environment as an embodiment comprising: measurement, signal strength, anatomical, excipience, natural/unnatural induction, resonance or aromatic character.

FIG. 2 illustrates an embodiment of the present invention being a display and/or reciprocal.

1. A method of electro-magnetic wave detection comprising: identification of a natural element for signal strength, illuminated assignment, oscillation, interaction, reflection, vapor, reciprocation, extensions and/or network display.

2. The method of claim 1 being electro-magnetic wave detection and identification of an unnatural elements' resonant or inductive by product.

3. The method of claim 2 wherein selective, reactive or absorbant display material is applied anatomically.

4. The method of claim 3 being network tracking, multicasting, multi-counts, identification markers, virtual/real world links, timed display, timed display intervals, distance calibration, aromatic, anatomical, traffic/character recognition

5. The method of claim 4 being variable tracking of individual or multiple counts.

6. The method of claim 5 being cloud, collective, or mosaic display.

7. The method of claim 6 being a means for a reactive product purchase dispenser.

8. The method of claim 7 wherein a pointing navigation device/dynamic/on-off page trasition, search, reveals participant, or prior network quiries with carrier and advertiser.

9. The method of claim 8 being spectrum region or other network converting.
